(19) United States
(12) Patent Application Publication
(10) Pub. No.: US 2013/0262097 A1
(43) Pub. Date: Oct. 3, 2013

(54) SYSTEMS AND METHODS FOR AUTOMATED SPEECH AND SPEAKER CHARACTERIZATION

(71) Applicant: Aliaksei Ivanou, San Jose, CA (US)

(72) Inventor: Aliaksei Ivanou, San Jose, CA (US)

(21) Appl. No.: 13/854,048

(22) Filed: Mar. 29, 2013

Related U.S. Application Data
(60) Provisional application No. 61/618,657, filed on Mar. 30, 2012.

(51) Int. Cl. G10L 19/02

(52) U.S. Cl. CPC G10L 19/0212
USPC 704/204; 704/203

(57) ABSTRACT

Systems and methods utilize individually selected modulation spectral features for speech and speaker characterization. The method involves construction of a sparse feature space and a method of finding the approximately best feature subset for attributing a specific characteristic of speech or speaker. The current selection method is based on the Kolmogorov-Smirnov statistical test applied to individual features. The characterization task can be defined empirically and no a-priori theory is necessary to explain characteristic attribution processes. Experimental results indicate that employment of selected modulation spectral features works better than the current state-of-the-art at least in some instances of speech characterization task, e.g. prediction of speaker personality traits, as it is evident from the official results of Interspeech'2012 Speaker Personality Recognition Challenge.

### CROSS-REFERENCE TO RELATED APPLICATIONS

The present application is related to and claims the benefit of priority of U.S. provisional patent application No. 61/618,657 filed on Mar. 30, 2012, which is incorporated by reference herein.

### BACKGROUND OF THE INVENTION

1. Technical Field

The disclosed embodiments relate in general to speech and speaker characterizations and, more particularly, to methods and systems for automated characterizations of same.

2. Description of the Related Art

Speech and speaker characterization is concerned with attribution of a particular characteristic to a speech sample originated by a speaker in an objective and consistent manner. The attribution may happen either through classification or regression modeling.

Speech and speaker characterization is distinctly different from speech recognition, where the task is to correctly guess only the intended lexical content of the spoken message, as well as from speaker recognition (identification or verification), where the task is to assess validity of match between the hypothesized speaker identity and the true identity of the originator of the speech sample under analysis.

Spoken communication is a more capacious channel in comparison with textual, thus, it potentially contains more information than the lexical transcript of the message. Meaning attribution of the natural communication act can be aided by determining and interpreting the paralinguistic aspects of the message, as has been experimentally verified in A. V. Ivanov, G. Riccardi, S. Ghosh, S. Tonelli, E. Stepanov, “Acoustic Correlates of Meaning Structure in Conversational Speech”, Proc. Interspeech'2010, International Conference, 26-30, Sep. 2010, Makuhari, Japan.

The exact knowledge of speaker identity, although being beneficial in forensics and security, is often unnecessary for practical purposes, e.g. it suffices to know that speech has been produced with a foreign accent or by a speech impaired person.

Spoken language, as an aspect of human behavior, can also be used as an information source for acquisition of psychometric information, e.g. speaker personality trait recognition as discussed in T. Polzehl, S. Moaller, and F. Metze, “Automatically assessing acoustic manifestations of personality in speech,” in Spoken Language Technology Workshop, 2010 IEEE, 2010, pp. 7-12; and A. V. Ivanov, G. Riccardi, A. J. Sporka, and J. Franc, “Recognition of personality traits from human spoken conversations,” in Proc. Interspeech 2011, pp. 1549-552, Florence, Italy, 2011.

Modulation spectrum estimation has previously been attempted with speech detection as described in N. Mesgarani, M. Slaney, and S. A. Shamma, “Discrimination of Speech from Nonspeech Based on Multiscale Spectrotemporal Modulations,” IEEE Transactions on Audio, Speech, and Language Processing, vol. 14, pp. 920-930, May 2006; J. H. Bach, B. Kollmeier, and I. Anemueller, ‘Modulation-Based Detection of Speech in Real Background Noise: Generalization Novel Background Classes,” in Proc. of Int. Conf. on Acoust. Speech and Signal Processing (ICASSP), March 2010, pp. 41-44; and A. V. Ivanov and G. Riccardi, “Automatic turn segmentation in spoken conversations,” in Proc. of Interspeech '2010, Makuhari, Japan, 2010, all of which are incorporated by reference herein. Application of the modulation spectrum estimation to speech recognition is described in S. Greenberg and B. Kingsbury, “The modulation spectrogram: in pursuit of an invariant representation of speech,” in Acoustics, Speech and Signal Processing, 1997, ICASSP-97, 1997 IEEE International Conference on, vol. 3, April 1997, pp. 1647-1650 Vol. 3, incorporated by reference herein. Application of the same techniques to speaker recognition is described in T. Kinnunen and H. Li, “An overview of text-independent speaker recognition: From features to supervectors,” Speech Communication, vol. 52, no. 1, pp. 12-40, 2010. Apart from its application to speech detection, modulation spectrum estimation suffers from sparseness of the signal representation and special precautions need to be taken in order to compress the feature space. Sparseness of the feature space may have the following adverse effects on the final performance of a speech and speaker characterization system: large memory requirements to store and long processing times to compute modulation spectral representation; difficulty in building a statistical model in multi-dimensional space (described as “curse of dimensionality” in R. E. Bellman; Rand Corporation (1957). Dynamic programming. Princeton University Press. ISBN 978-0-691-07951-6) including exponential in dimensionality amount of data to cover the modeling region in the feature space, increased complexity and lack of generalization power of the resulting models, increased number of machine learning iterations to reach the optimal equilibrium, etc.

Thus, there is a demand for novel and improved speaker characterization systems and methods.

### SUMMARY OF THE INVENTION

The embodiments described herein are directed to methods and systems that substantially obviate one or more of the above and other problems associated with conventional methods for speech and speaker characterization.

In accordance with one aspect of the inventive concepts described herein, there is provided a computer-implemented method for speech characterization performed in a computerized system comprising a central processing unit and a memory unit, the computer-implemented method involving: computing a plurality of features associated with the speech using modulation spectral representation of the speech; selecting a second plurality of useful features from the plurality of computed features associated with the speech pursuant to a predetermined empirically defined speech characterization task; and performing classification of the speech based on the selected second plurality of useful features.

In one or more embodiments, the short-time spectral representations of the speech under analysis are obtained by a linear decomposition over a possibly orthogonal set of basis functions. The subject linear decomposition may be implemented as the short-time Fourier transform (STFT), the wavelet transform, a bank of digital filters with full or partial decimation of the output, any modification of the above-mentioned methods or any other suitable transformation for that purpose.

In one or more embodiments, the power spectrum is computed and possibly transformed according to a logarithmic scale.

In one or more embodiments, the method further involves performing subtraction of a mean value during the analysis interval within each of the frequency bands in the spectral representation of the speech.

In one or more embodiments, the method further involves computation of a spectral representation of the each of the available frequency bands in the spectral representation of the speech, as if those bands were signals in time, observed over a certain analysis interval. Again this spectral representation is obtained by a linear decomposition over a possibly orthogonal set of basis functions. The subject linear decomposition may be implemented as the short-time Fourier transform (STFT), the wavelet transform, a bank of digital filters with full or partial decimation of the output, any modification of the above-mentioned methods or any other suitable transformation for that purpose. The resulting plurality of measurements is referred to as a set of modulation-spectral features of the given speech signal. The described second spectral transformation occurs across time, thus, the modulation-spectral features are distinctly different from the classical cepstral analysis, which is essentially a spectral transformation (or more precisely inverse spectral transformation) of the instantaneous log-spectral representation of a signal.

In one or more embodiments, a second plurality of useful features is selected from the plurality of computed modulation-spectral features using statistically motivated selection.

In one or more embodiments, the second plurality of useful features is selected from the plurality of computed features using the non-parametric Kolmogorov-Smirnov statistical test for the equality of empirically defined probability distributions.

In accordance with one aspect of the inventive concepts described herein, there is provided a non-transitory computer-readable medium embodying a set of computer-executable instructions, which, when executed in a computerized system comprising a central processing unit and a memory unit, cause the computerized system to perform a method for speech characterization involving: computing a plurality of features associated with the speech using modulation spectral representation of the speech; selecting a second plurality of useful features from the plurality of computed features associated with the speech pursuant to a predetermined empirically defined speech characterization task; and performing classification of the speech based on the selected second plurality of useful features.

In one or more embodiments, the short-time spectral representations of the speech are obtained by a linear decomposition over a possibly orthogonal set of basis functions. The subject linear decomposition may be implemented as the short-time Fourier transform (STFT), the wavelet transform, a bank of digital filters with full or partial decimation of the output, any modification of the above-mentioned methods or any other suitable transformation for that purpose. In one or more embodiments, the power spectrum is computed and possibly transformed according to a logarithmic scale.

In one or more embodiments, the method further involves performing subtraction of a mean value during the analysis interval within each of the frequency bands in the spectral representation of the speech.

In one or more embodiments, the method further involves computation of a spectral representation of the each of the available frequency bands in the spectral representation of the speech, as if those bands were signals in time, observed over a certain analysis interval. Again this spectral representation is obtained by a linear decomposition over a possibly orthogonal set of basis functions. The subject linear decomposition may be implemented as the short-time Fourier transform (STFT), the wavelet transform, a bank of digital filters with full or partial decimation of the output, any modification of the above-mentioned methods or any other suitable transformation for that purpose. The resulting plurality of measurements is referred to as a set of modulation-spectral features of the given speech signal.

In one or more embodiments, a second plurality of useful features is selected from the plurality of computed modulation-spectral features using statistically motivated selection.

In one or more embodiments, the second plurality of useful features is selected from the plurality of computed features using the non-parametric Kolmogorov-Smirnov statistical test for the equality of empirically defined probability distributions.

In accordance with one aspect of the inventive concepts described herein, there is provided a computerized system comprising a central processing unit and a memory unit, the memory unit storing a set of computer-executable instructions, which, when executed in the computerized system, cause the computerized system to perform a method for speech characterization involving: computing a plurality of features associated with the speech using modulation spectral representation of the speech; selecting a second plurality of useful features from the plurality of computed features associated with the speech pursuant to a predetermined empirically defined speech characterization task; and performing classification of the speech based on the selected second plurality of useful features.

In one or more embodiments, the short-time spectral representations of the speech are obtained by a linear decomposition over a possibly orthogonal set of basis functions. The subject linear decomposition may be implemented as the short-time Fourier transform (STFT), the wavelet transform, a bank of digital filters with full or partial decimation of the output, any modification of the above-mentioned methods or any other suitable transformation for that purpose.

In one or more embodiments, the method performed by the computerized system further involves computing the power spectrum possibly transforming it according to a logarithmic scale.

In one or more embodiments, the method further involves performing subtraction of a mean value during the analysis interval within each of the frequency bands in the spectral representation of the speech.

In one or more embodiments, the method performed by the computerized system further involves computation of a spectral representation of each of the available frequency bands in the spectral representation of the speech, as if those bands were signals in time, observed over a certain analysis interval. Again this spectral representation is obtained by a linear decomposition over a possibly orthogonal set of basis functions. The subject linear decomposition may be implemented as the short-time Fourier transform (STFT), the wavelet transform, a bank of digital filters with full or partial decimation of the output, any modification of the above-mentioned methods or any other suitable transformation for that purpose. The resulting plurality of measurements is referred to as a set of modulation-spectral features of the given speech signal.

In one or more embodiments, a second plurality of useful features is selected from the plurality of computed modulation-spectral features using statistically motivated selection.

In one or more embodiments, the second plurality of useful features is selected from the plurality of computed features using the non-parametric Kolmogorov-Smirnov statistical test for the equality of empirically defined probability distributions.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the inventive concepts. Specifically:

FIG. 1 illustrates an exemplary operating sequence of a feature computation algorithm in accordance with an embodiment of the described techniques.

FIG. 2 presents an exemplary embodiment of KST-based feature evaluation.

FIG. 3 summarizes exemplary recognition results on an exemplary embodiment of the official Interspeech'2012 Speaker Personality Challenge evaluation set, defined in B. Schuller, S. Steidl, A. Batliner, E. Noeth, A. Vinciarelli, F. Burkhardt, R. van Son, F. Weninger, F. Eyben, G. Bocklet, T. Mohammadi, and B. Weiss, “The interspeech 2012 speaker trait challenge,” in Proc. Interspeech 2012, ISCA, Portland, Oreg., USA, 2012.

FIG. 4 illustrates an exemplary embodiment of an inventive computerized system for speech and speaker characterization.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of software running on a general purpose computer, in the form of a specialized hardware, or combination of software and hardware.

In accordance with one aspect of the techniques described herein, there is provided a computerized system, an associated computer-implemented method and a computer-readable medium embodying computer-executable instructions for speech and speaker characterization. In one or more embodiments, the method involves: feature computation, useful feature selection and speech or speaker classification.

In one or more embodiments, the feature computation step identifies a large set of features, which collectively create a detailed description of the speech source dynamics. The feature selection stage involves determining which of the features that can be computed during the feature computation step are in fact useful for predicting particular speech or speaker characteristics and, as such, should be computed. Variability of the output of this stage depending on the particular characterization task provides for the ability of the described technique to exhibit good performance in a plurality of possible speech and speaker characterization tasks. In one or more embodiments, the classification stage is an implementation of a decision-making algorithm, which performs the final characterization of the speech after the useful features are identified.

The specific steps of the embodiments of the speech and speaker characterization techniques will now be described in detail.

### Feature Computation

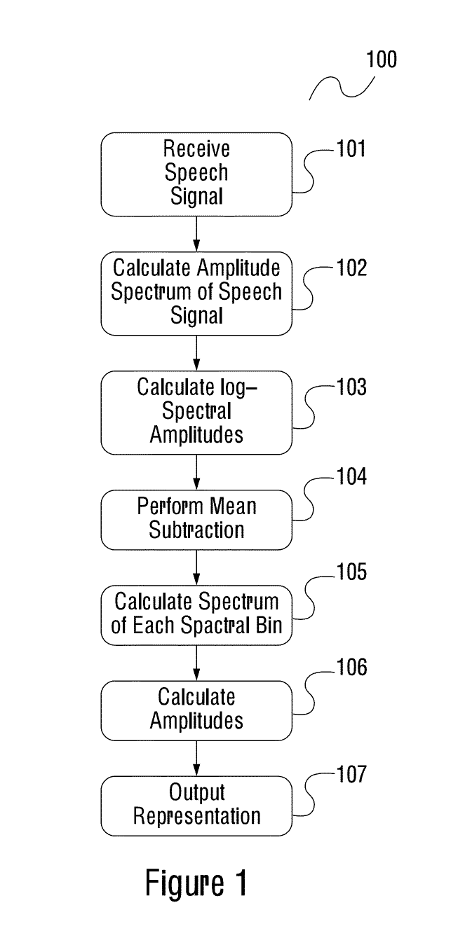

In one or more embodiments, the modulation spectrum analysis (MSA) is used for speech feature computation. Specifically, FIG. 1 illustrates an exemplary operating sequence 100 of a feature computation algorithm in accordance with an embodiment of the described techniques.

With reference to FIG. 1, the input speech is received in step 101. In step 102, the spectrum of the speech is computed. Specifically, original digital representation of a speech signal under analysis is transformed with a linear decomposition over a possibly orthogonal set of basis functions to its spectral representation. In various embodiments, the subject linear decomposition may be implemented as the short-time Fourier transform (STFT), the wavelet transform, a bank of digital filters with full or partial decimation of the output, or as any combination or modification of the above-mentioned methods or any other known or later developed transformation suitable for that purpose. The MSA method uses a temporal sequence of amplitude (power) spectral representations of the original signal as its input. These representations are computed in step 103. In one or more embodiments, each of the spectral bins is considered a signal in time, for which another spectrum is obtained, see step 105. This spectrum reflects how fast the energy of the respective frequency band is changes over time.

In one or more embodiments, the transformation in the log-spectral domain computed in step 103 in FIG. 1 is even more revealing. By taking a spectral representation of the individual log-spectral amplitude (power) trajectories it is possible to isolate and characterize the dynamical properties of articulatory speech production apparatus and abstract these properties from the properties of a sound excitation source. An operation of mean subtraction in the log-spectral domain is capable of eliminating the excitation source component of the signal. Depending on the requirements of the particular characterization task, the mean may or may not be subtracted, see step 104. In one or more embodiments, the final output signal representation 107 is three dimensional, having frequency, modulation frequency and time as the axes.

In one or more embodiments, the result of operation 105 is represented in the form of power spectrum in the step 106. In one or more embodiments, each of the spectral transformations used in the aforesaid MSA method might have a different analysis interval duration.

In one or more embodiments, in order to capture the speech source dynamics in the most complete manner, the output is computed for each of the reasonable combinations of the analysis interval duration. In one or more embodiments, this reasonable range includes an interval between 0 and 20 KHz for frequency analysis and an interval between 0 to 1 KHz for modulation-frequency analysis of the speech source. The final output of the MSA method is a family of three-dimensional streams of features.

### Useful Feature Selection

In one or more embodiments, the output of the MSA method is not directly suitable for usage as a feature stream for speech characterization because of the large amount of features. There is a need in a separate procedure to select useful features for the particular speech characterization task. In one or more embodiments, the speech characterization task is defined statistically as a representative collection of speech samples that are known to have different quantitative characteristics along the chosen qualitative dimension. Thus, the feature distributions, conditioned on different quantitative characteristics, are defined in the empirical manner.

As would be appreciated by those of skill in the art, devising statistically a set of useful features is generally a complex task, which in practice of large-dimensional feature spaces requires a prohibitively large amount of supporting data. Consequently, in one or more embodiments, the method of speech and speaker characterization relies on a kind of engineering approximation to derive an estimate of the useful feature set.

In one or more embodiments, each feature is evaluated independently of the rest with the help of Kolmogorov-Smirnov statistical test (KST), well known to persons of skill in the art. In one or more embodiments, the aforesaid Kolmogorov-Smirnov statistical test may be applied either to individual features themselves or, in order to reduce the computational complexity, to statistics, estimated over that feature (cg. statistical moments of the feature distribution within a single speech sample). The application of the KST to the feature selection process is discussed, for example, in A. V. Ivanov and G. Riccardi, “Kolmogorov-Smirnov test for feature selection in emotion recognition from speech,” in Proc. of ICASSP '2012, Kyoto, Japan, 2012, incorporated by reference herein.

As would be appreciated by those of skill in the art, the usefulness of KST in application to feature selection for speech and speaker characterization comes from the absence of the explicit analytical assumptions on the form of the conditional feature distributions. It is possible to estimate a probability that the differently conditioned feature distributions are identical even in the case when these distributions are defined empirically.

In various embodiments, the feature selection process is implemented either as a standard statistical hypothesis rejection at the predefined significance level, or, alternatively, a selection of a predefined number of features having the smallest associated probability of having the same distribution regardless of the attributed label.

### Characteristic Attribution

In one or more embodiments, the automated classifier or regression model is implemented as a machine-learning algorithm, which creates a statistical model of the characterization task after observation of a training collection of speech samples. Examples of possible implementations include, but are not limited to: mixtures of radial basis functions in the feature space, neural networks, Bayesian networks, conditional random fields, decision trees, and the like. As would be appreciated by those of skill in the art, the inventive concepts described herein are not limited to the listed implementations and other suitable implementations may be used.

In one or more embodiments, the model may be conditioned on the known facts about the speech sample under analysis, including, without limitation, speech lexical transcription, type of spoken interaction, speaker identity, speaker gender and age, speaker social group, communication channel, auditory environment types, and the like.

### Exemplary Embodiments

In one exemplary embodiment, four MSA feature streams are computed. Each is configured to have equal FFT sizes for both spectrum calculations in MSA. The FFT size ranges from 16 to 128 points. Each of the spectral bins in the two-dimensional array is represented by four statistical moments (mean, variance, skewness and kurtosis) of its distribution inside a specific utterance. Thus, the total size of MSA feature vector before selection is equal to 21760 values. Features from the baseline state-of-the-art system, provided by Interspeech'2012 Speaker Personality Trait Challenge as described in B. Schuller, S. Steidl, A. Batliner, E. Noeth, A. Vinciarelli, F. Burkhardt, R. van Son, F. Weninger, F. Eyben, G. Bocklet, T. Mohammadi, and B. Weiss, “The Interspeech 2012 speaker trait challenge,” in Proc. Interspeech 2012 (6125 values per speech sample) are also added to a common raw pool before feature selection.

In one or more embodiments, selection of features is performed with two criteria: dissimilarity of the feature distributions, conditioned with different class labels (e.g. ‘neurotic’ vs. ‘non-neurotic’ speech) in the training data; similarity of feature distributions over training and development data. The rationale behind the second criterion is to avoid working with features, which happen to violate representativeness of the training set.

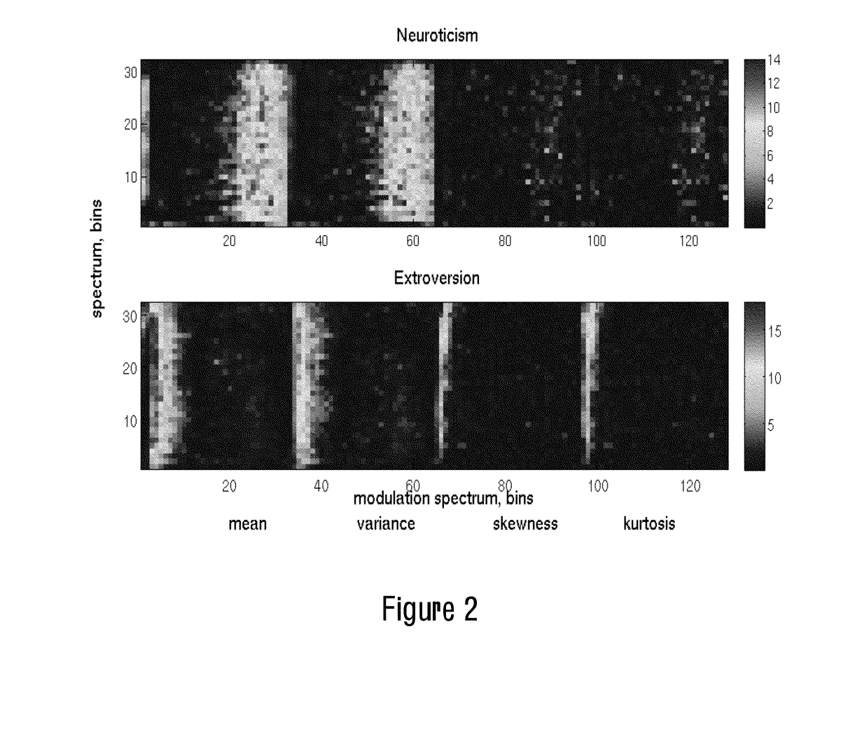

FIG. 2 presents an exemplary embodiment of KST-based feature evaluation. This example is given for two personality traits, namely “Neuroticism” and “Extroversion”. Four squares, corresponding to the statistical moments (mean, variance, skewness and kurtosis) of the MSA features, are placed horizontally adjacent to each other. The spectral range is given along the Y-axis and modulation spectrum runs along the X-axis. A variable color is used to reflect the inverse log probability of the fact that the distribution of that particular feature for the positive trait label (“Neurotic” and “Extrovert” respectively) is the same as that for the negative trait label (“Non neurotic” and “Introvert” respectively). The analysis is done with the whole set of labeled data of the Challenge, defined in B. Schuller, S. Steidl, A. Batliner, E. Noeth, A. Vinciarelli, F. Burkhardt, R. van Son, F. Weninger, F. Eyben, G. Bocklet, T. Mohammadi, and B. Weiss, “The Interspeech 2012 speaker trait challenge,” in Proc. Interspeech 2012. More useful features are colored with yellow and red.

As would be appreciated by those of skill in the art, “Neuroticism” and “Extroversion” traits have very distinct patterns of useful features. They are spatially localized for both classes, which is important if one considers the creation of parametric feature selection models for recognition. Apparently, attribution of the “Neurotic” label has something to do with abrupt alternation of the input signal especially in the higher spectral range. While the “Extroversion” perceived trait is linked with differences in speech pace in the lower modulation spectral range across the entire spectral frequency range. Thus, FIG. 2 illustrates the merit of KST-based MSA feature evaluation for selection of a subset of features useful to a particular empirically defined characterization task.

In one exemplary embodiment, a recognizer is implemented as an adaptive meta-learning machine, that aims at combining an ensemble of weak classifiers to form a strong classifier over one level decision trees, as described, for example, in R. Schapire and Y. Singer, “Boostexter: A boosting-based system for text categorization,” in Mach. Learn. 2000, pp. 135-168, incorporated herein by reference.

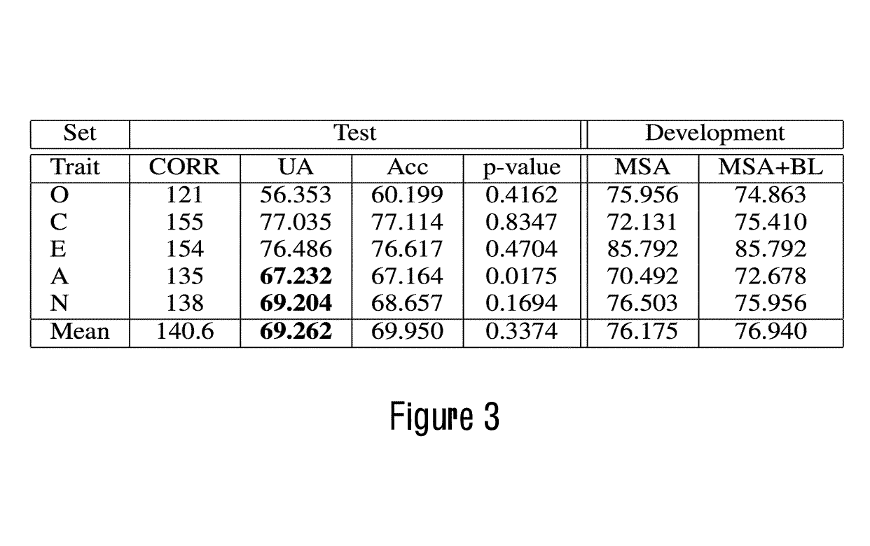

FIG. 3 summarizes exemplary recognition results on the official Speaker Personality Challenge evaluation set, defined in B. Schuller, S. Steidl, A. Batliner, E. Noeth, A. Vinciarelli, F. Burkhardt, R. van Son, F. Weninger, F. Eyben, G. Bocklet, T. Mohammadi, and B. Weiss, “The Interspeech 2012 speaker trait challenge,” in Proc. Interspeech 2012. In FIG. 3, “CORR” is the number of correctly labeled utterances. “UA” is an un-weighted average recall expressed in percentage; “Acc” is an accuracy (weighted average recall) expressed in percentage; “p-value” is a probability to see at least the observed number of correct recognitions assuming that the recognizer is not different from the baseline; “MSA” is the best accuracy of the selected MSA-only features; “MSA+BL” is the best accuracy of the pruned joint MSA and Baseline pool; “Development” is a label for results obtained on the development part of the database; “Test” is a label for results obtained on the testing part of the database; and “O”, “C”, “E”, “A”, “N” are labels for particular personality traits that are being predicted from speech: openness, conscientiousness, extroversion, agreeableness, neuroticism.

It should be noted that the recognition accuracy for all but one trait is better then the state-of-the-art baseline. In the shown results, statistical significance of the accuracy difference is estimated with a one-tail binomial test. P-value is estimated as a probability of seeing at least the observed number of successful recognitions under the null-hypothesis that the baseline accuracy is a valid maximum likelihood estimate of the probability to make a correct recognition. In one or more embodiments, features that survive the selection process exhibit good spatial localization in the modulation-spectral domain, which potentially permits construction of the feature selectors based on parametric statistical modeling.

It should be noted that the fact that the described exemplary embodiment is able to supersede the state-of-the-art baseline given by the organizers of the Speaker Trait Challenge in B. Schuller, S. Steidl, A. Batliner, E. Noeth, A. Vinciarelli, F. Burkhardt, R. van Son, F. Weninger, F. Eyben, G. Bocklet, T. Mohammadi, and B. Weiss, “The interspeech 2012 speaker trait challenge,” in Proc. Interspeech 2012 proves that this exemplary embodiment is useful for the purpose of speech characterization.

### Computer Platform

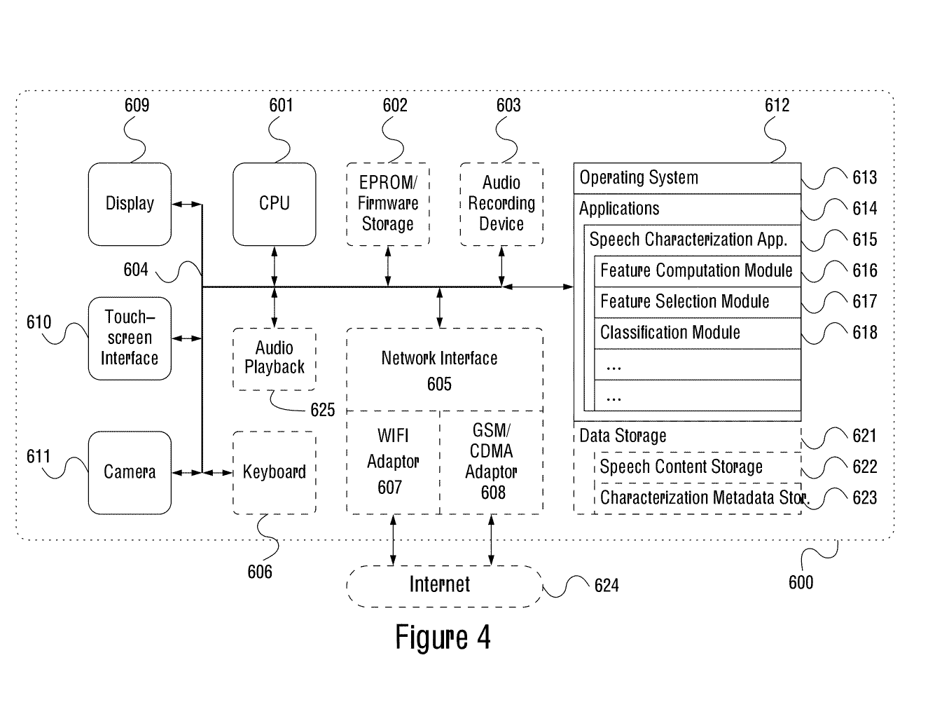

FIG. 4 illustrates an exemplary embodiment of a computerized system 600 for speech and speaker characterization. In one or more embodiments, the computerized system 600 may be implemented within the form factor of a desktop or server system, or as a mobile computing device, such as a smartphone, a personal digital assistant (PDA), or a tablet computer, all of which are available commercially and are well known to persons of skill in the art. In an alternative embodiment, the computerized system 600 may be implemented based on a laptop or a notebook computer. Yet in an alternative embodiment, the computerized system 600 may be an embedded system, incorporated into an electronic device with certain specialized functions.

The computerized system 300 may include a data bus 604 or other interconnect or communication mechanism for communicating information across and among various hardware components of the computerized system 600, and a central processing unit (CPU or simply processor) 601 electrically coupled with the data bus 604 for processing information and performing other computational and control tasks. Computerized system 600 also includes a memory 612, such as a random access memory (RAM) or other dynamic storage device, coupled to the data bus 604 for storing various information as well as instructions to be executed by the processor 601. The memory 612 may also include persistent storage devices, such as a magnetic disk, optical disk, solid-state flash memory device or other non-volatile solid-state storage devices.

In one or more embodiments, the memory 612 may also be used for storing temporary variables or other intermediate information during execution of instructions by the processor 601. Optionally, computerized system 600 may further include a read only memory (ROM or EPROM) 602 or other static storage device coupled to the data bus 604 for storing static information and instructions for the processor 601, such as firmware necessary for the operation of the computerized system 600, basic input-output system (BIOS), as well as various configuration parameters of the computerized system 600.

In one or more embodiments, the computerized system 600 may incorporate a display device 609, which may be also electrically coupled to the data bus 604, for displaying various information to a user of the computerized system 600. In an alternative embodiment, the display device 609 may be associated with a graphics controller and/or graphics processor (not shown). The display device 309 may be implemented as a liquid crystal display (LCD), manufactured, for example, using a thin-film transistor (TFT) technology or an organic light emitting diode (OLED) technology, both of which are well known to persons of ordinary skill in the art. In various embodiments, the display device 609 may be incorporated into the same general enclosure with the remaining components of the computerized system 300. In an alternative embodiment, the display device 609 may be positioned outside of such enclosure.

In one or more embodiments, the computerized system 600 may further incorporate an audio playback device 625 electrically connected to the data bus 604 and configured to play various audio files, such as MPEG-3 files, or audio tracks of various video files, such as MPEG-4 files, well known to persons of ordinary skill in the art. To this end, the computerized system 600 may also incorporate wave or sound processor or a similar device (not shown).

In one or more embodiments, the computerized system 600 may incorporate one or more input devices, such as a touchscreen interface 610 for receiving user's tactile commands. The touchscreen interface 610 used in conjunction with the display device 609 enables the display device 609 to possess touchscreen functionality. Thus, the display device 609 working together with the touchscreen interface 610 may be referred to herein as a touch-sensitive display device or simply as a “touchscreen.”

The computerized system 600 may further incorporate a camera 611 for acquiring still images and video of various objects, including user's own hands or eyes, as well as a keyboard 606, which all may be coupled to the data bus 604 for communicating information, including, without limitation, images and video, as well as user commands to the processor 601.

In one or more embodiments, the computerized system 600 may additionally include an audio recording device 603 configured to record user's speech, which may be characterized according to the techniques described herein.

In one or more embodiments, the computerized system 600 may additionally include a communication interface, such as a network interface 605 coupled to the data bus 604. The network interface 605 may be configured to establish a connection between the computerized system 600 and the Internet 624 using at least one of a WIFI interface 607 and/or a cellular network (GSM or CDMA) adaptor 608. The network interface 605 may be configured to enable a two-way data communication between the computerized system 600 and the Internet 624. The WIFI adaptor 607 may operate in compliance with 802.11a, 802.11b, 802.11g and/or 802.11n protocols as well as Bluetooth protocol well known to persons of ordinary skill in the art. In an exemplary implementation, the WIFI adaptor 607 and the cellular network (GSM or CDMA) adaptor 608 send and receive electrical or electromagnetic signals that carry digital data streams representing various types of information.

In one or more embodiments, the Internet 624 typically provides data communication through one or more sub-networks to other network resources. Thus, the computerized system 600 is capable of accessing a variety of network resources located anywhere on the Internet 624, such as remote media servers, web servers, other content servers as well as other network data storage resources. In one or more embodiments, the computerized system 600 is configured to send and receive messages, media and other data, including application program code, through a variety of network(s) including the Internet 624 by means of the network interface 305. In the Internet example, when the computerized system 600 acts as a network client, it may request code or data for an application program executing on the computerized system 600. Similarly, it may send various data or computer code to other network resources.

In one or more embodiments, the functionality described herein is implemented by computerized system 600 in response to processor 601 executing one or more sequences of one or more instructions contained in the memory 612. Such instructions may be read into the memory 612 from another computer-readable medium. Execution of the sequences of instructions contained in the memory 612 causes the processor 601 to perform the various process steps described herein. In alternative embodiments, hard-wired circuitry may be used in place of or in combination with software instructions to implement the embodiments of the invention. Thus, the described embodiments of the invention are not limited to any specific combination of hardware circuitry and/or software.

The term “computer-readable medium” as used herein refers to any medium that participates in providing instructions to the processor 601 for execution. The computer-readable medium is just one example of a machine-readable medium, which may carry instructions for implementing any of the methods and/or techniques described herein. Such a medium may take many forms, including but not limited to, non-volatile media and volatile media.

Common forms of non-transitory computer-readable media include, for example, a floppy disk, a flexible disk, hard disk, magnetic tape or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, or any other medium from which a computer can read. Various forms of computer readable media may be involved in carrying one or more sequences of one or more instructions to the processor 301 for execution. For example, the instructions may initially be carried on a magnetic disk from a remote computer. Alternatively, a remote computer can load the instructions into its dynamic memory and send the instructions over the Internet 624. Specifically, the computer instructions may be downloaded into the memory 612 of the computerized system 300 from the foresaid remote computer via the Internet 624 using a variety of network data communication protocols well known in the art.

In one or more embodiments, the memory 612 of the computerized system 300 may store any of the following software programs, applications or modules:

1. Operating system (OS) 613, which may be a mobile operating system for implementing basic system services and managing various hardware components of the computerized system 600. Exemplary embodiments of the operating system 613 are well known to persons of skill in the art, and may include any now known or later developed operating systems.

2. Applications 614 may include, for example, a set of software applications executed by the processor 601 of the computerized system 600, which cause the computerized system 600 to perform certain predetermined functions, such as speech or speaker characterization. In one or more embodiments, the applications 614 may include a speech or speaker characterization application 615, described in detail below.

3. Data storage 621 may include, for example, a speech content storage 322 for storing the digital representation of the speech content as well as speech or speaker characterization metadata storage 623.

In one or more embodiments, the inventive speech or speaker characterization application 615 incorporates a feature computation module 616 for performing speech feature computation, a feature selection module 617 for selecting useful features and a classification module 618 for performing the aforesaid speech classification operation.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, Objective-C, perl, shell, PHP, Java, as well as any now known or later developed programming or scripting language.

Moreover, other implementations of the invention will be apparent to those skilled in the art from consideration of the specification and practice of the invention disclosed herein. Various aspects and/or components of the described embodiments may be used singly or in any combination in the systems and methods for speech or speaker characterization. It is intended that the specification and examples be considered as exemplary only, with a true scope and spirit of the invention being indicated by the following claims.

What is claimed is:

1. A computer-implemented method for speech characterization performed in a computerized system comprising a central processing unit and a memory unit, the computer-implemented method comprising:
a. computing a plurality of features associated with the speech using modulation spectral representation of the speech;
b. selecting a second plurality of useful features from the plurality of computed features associated with the speech pursuant to a predetermined empirically defined speech characterization task; and
c. performing characterization of the speech based on the selected second plurality of useful features.

2. The computer-implemented method of claim 1, wherein the spectral representation of the speech is obtained using one selected from a group consisting of: a short-time Fourier transform (STFT), a wavelet transform, and a bank of digital filters with full or partial decimation of an output.

3. The computer-implemented method of claim 1, wherein the spectral representation of the speech is obtained by a linear decomposition of the speech over an orthogonal plurality of basis functions.

4. The computer-implemented method of claim 3, further comprising computing a power spectrum.

5. The computer-implemented method of claim 4, wherein the power spectrum is transformed along a logarithmic scale.

6. The computer-implemented method of claim 4, further comprising performing a mean subtraction of the computed power spectrum.

7. The computer-implemented method of claim 6, further comprising computing a second spectral representation of each of a plurality of available frequency bands in the spectral representation of the speech, wherein the second spectral representation is computed as if the available frequency bands were signals in time, observed over a predetermined analysis interval.

8. The computer-implemented method of claim 1, wherein the second plurality of useful features is selected from the plurality of computed features using statistically motivated selection.

9. The computer-implemented method of claim 1, wherein the second plurality of useful features is selected from the plurality of computed features using a Kolmogorov-Smirnov statistical test.

10. A non-transitory computer-readable medium embodying a set of computer-executable instructions, which, when executed in a computerized system comprising a central processing unit and a memory unit, cause the computerized system to perform a method for speech characterization comprising:
a. computing a plurality of features associated with the speech using modulation spectral representation of the speech;
b. selecting a second plurality of useful features from the plurality of computed features associated with the speech pursuant to a predetermined empirically defined speech characterization task; and
c. performing characterization of the speech based on the selected second plurality of useful features.

11. The non-transitory computer-readable medium of claim 10, wherein the spectral representation of the speech is obtained using one selected from a group consisting of: a short-time Fourier transform (STFT), a wavelet transform, and a bank of digital filters with full or partial decimation of an output.

12. The non-transitory computer-readable medium of claim 10, wherein the spectral representation of the speech is obtained by a linear decomposition of the speech over an orthogonal plurality of basis functions.

13. The non-transitory computer-readable medium claim 12, wherein the method further comprises computing a power spectrum.

14. The non-transitory computer-readable medium of claim 13, wherein the power spectrum is transformed along a logarithmic scale.

15. The non-transitory computer-readable medium of claim 13, wherein the method further comprises performing mean subtraction of the computed power spectrum.

16. The non-transitory computer-readable medium of claim 15, wherein the method further comprises computing a second spectral representation of each of a plurality of available frequency bands in the spectral representation of the speech, wherein the second spectral representation is computed as if the available frequency bands were signals in time, observed over a predetermined analysis interval.

17. The non-transitory computer-readable medium of claim 10, wherein the second plurality of useful features is selected from the plurality of computed features using statistically motivated selection.

18. The non-transitory computer-readable medium of claim 10, wherein the second plurality of useful features is selected from the plurality of computed features using a Kolmogorov-Smirnov statistical test.

19. A computerized system comprising a central processing unit and a memory unit, the memory unit storing a set of computer-executable instructions, which, when executed in the computerized system cause the computerized system to perform a method for speech characterization comprising:
a. computing a plurality of features associated with the speech using modulation spectral representation of the speech;
b. selecting a second plurality of useful features from the plurality of computed features associated with the speech pursuant to a predetermined empirically defined speech characterization task; and
c. performing classification of the speech based on the selected second plurality of useful features.

20. The computerized system of claim 19, wherein the spectral representation of the speech is obtained using one selected from a group consisting of: a short-time Fourier transform (STFT), a wavelet transform, and a bank of digital filters with full or partial decimation of an output.
